(19) United States
(12) Patent Application Publication
(10) Pub. No.: US 2006/0031443 A1
(43) Pub. Date: Feb. 9, 2006

(54) System configuration and policies using set concepts

(75) Inventors: Kelly Scott Carpenter, Elgin, TX (US); Khalid Filali-Adib, Austin, TX (US); Brent William Yardley, Hillsboro, OR (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/849,608

(22) Filed: May 20, 2004

(51) Int. Cl. G06F 15/173

(52) U.S. Cl. 709/223

(57) ABSTRACT

Set theory is used in a policy manager to manage sets of devices, each having multiple attributes, and can be used to evaluate and manage the individual attributes of the devices as groups. Each element of a network to be managed is defined by its attributes and treated as a point in a multi-dimensional space. Policy is expressed as a set of allowable points in the same space and the determination of whether a network complies with a policy is a matter checking to see if the elements exist as members of the set of allowable possibilities. Using this methodology, entire networks can be checked against a policy by determining if the set of points comprising the elements of the network are a subset of the set of allowable points.

### BACKGROUND OF THE INVENTION

1. Technical Field

The invention relates generally to the administrative management of computer networks and more specifically to a system and method for describing configurations and policies in policy engines.

2. Description of Related Art

Network administrators are charged with managing the network of computers within a business or other entity. This management can involve seeing that data is backed up regularly, monitoring available file space, performing load balancing to keep server loads balanced, updating systems when new software becomes available, etc. Because of the complexity of many large systems and the possibility of human error involved, programs known as policy managers are installed to automate these processes. These policy managers are designed to receive desired policies expressed in Boolean relationships and to interact with a system to be sure that the desired policies are implemented.

When operating on large architectures such as storage networks, the policy manager must evaluate myriad devices, each with multiple attributes and multiple possible values for those attributes. The ability to evaluate a number of objects with their multiple attributes at the same time is very important. There are a number of limitations in the current Boolean approach.

Given the elements of a network, each having a number of different attributes, a policy manager can evaluate each element and determine whether or not that element fits the policy that govern it. However, the policy manager cannot evaluate a group of similar elements in the network and report how many elements fit the policy; nor can it report all elements that do not fit the policy.

An example using familiar objects, such as a basket of fruit, can help clarify. The basket contains a number of fruit, each fruit having a number of attributes, for example, a unique identifier (A, B, C, etc.), a fruit type (apples, oranges, bananas, and pears), a color (red, yellow, green, etc.), a skin type (edible, not edible), size (1, 2, 3, etc.), and weight (1, 2, 3, etc.). In the existing architectures, each piece of fruit would be submitted to the policy manager, which can evaluate the attributes of that piece and determine whether or not it fits a policy, such as whether or not the current piece is a red apple having a weight of at least 5. However, the policy manager is not capable of taking the basket of fruit and reporting the number of pieces of fruit that are red apples having a weight of at least 5; neither is it capable of providing a list of all of the pieces that fit this description.

Additionally, the expression of many policies often becomes cumbersome and hard to follow. For example, in a diverse collection of systems, one administrative policy can be simply that each system has an adequate level of software loaded. One of the rules following from this policy might be: if the system operating system (OS) is AIX, the software level must be Aix 5.2.G, Aix 5.2.Z, or Aix.5.3.B; if the system OS is Linux SuSe and the central processing unit (CPU) type is 0x86, the software level must be Suse1.2 or Suse1.4 and the system must have a RAM memory capacity between 512 MB and 1600 MB; if the system OS is Windows XP, the software level must be Win 1.5 and the system must have at least 2 CPUs. This policy is expressed by the following: [(System.OS=AIX) && [(System.OS.Level=Aix.5.2.G)∥(System.OS.Level=Aix.5.2.Z)∥(System.OS.Level=Aix.5.3.B)])]∥[(System.OS=LinuxSuSe) && (System.CPU.Type=0x86) && [(System.OS.Level=Suse 1.2)∥(System.OS.Level=Suse 1.4) && [System.Memory.Capacity=≧512) && (System.Memory.Capacity≦1600]]∥[(System.OS=WindowsXP) && (System.OS.Level=Win1.5) && (System.CPU.Number≧2)]. This expression is neither easy to follow nor easy to change.

Thus, it would be desirable to provide a method of evaluating groups of objects that can provide more information than it is possible to derive from the current applications and that can be expressed more simply and understandably.

### SUMMARY OF THE INVENTION

The present invention uses set theory to provide a device, a method, and a system that can operate on a collection of elements, each having multiple attributes, and can evaluate not only their individual attributes, but also the similarities and differences between the elements.

Each element of a network is defined by its attributes and can be thought of as a point in a multi-dimensional space. Policy is then expressed as a set of allowable points in the same space and the determination of whether a network complies with a policy is a matter checking to see if the elements exist as members of the set of allowable possibilities. Using this methodology, entire networks can be checked against a policy by determining if the set of points comprising the elements of the network are a subset of the set of allowable points.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented.

FIG. 2 depicts a block diagram of a data processing system that may be implemented as a server in which the present invention may be implemented.

FIG. 3 depicts an exemplary policy that has been implemented using a preferred embodiment of the present invention.

FIG. 4 depicts another exemplary policy that has been implemented using a preferred embodiment of the present invention.

FIG. 5 depicts another exemplary policy that has been implemented using a preferred embodiment of the present invention.

FIG. 6 depicts another exemplary policy that has been implemented using a preferred embodiment of the present invention.

### DETAILED DESCRIPTION OF THE PREFERRED EMBODIMENT

Rather than evaluating objects one at a time, the present invention models the information that is required for a policy into a set and analyzes relationships between elements of the set and between sets. The elements of a network are simply its parts, e.g., server, memory, switch, port, operating system, etc. The attributes of each element are those things that define the element and will vary depending on the type of element. For example, a server can have the attributes of vendor, model, and processing speed, to name a few. Software can have the attributes of vendor and version.

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

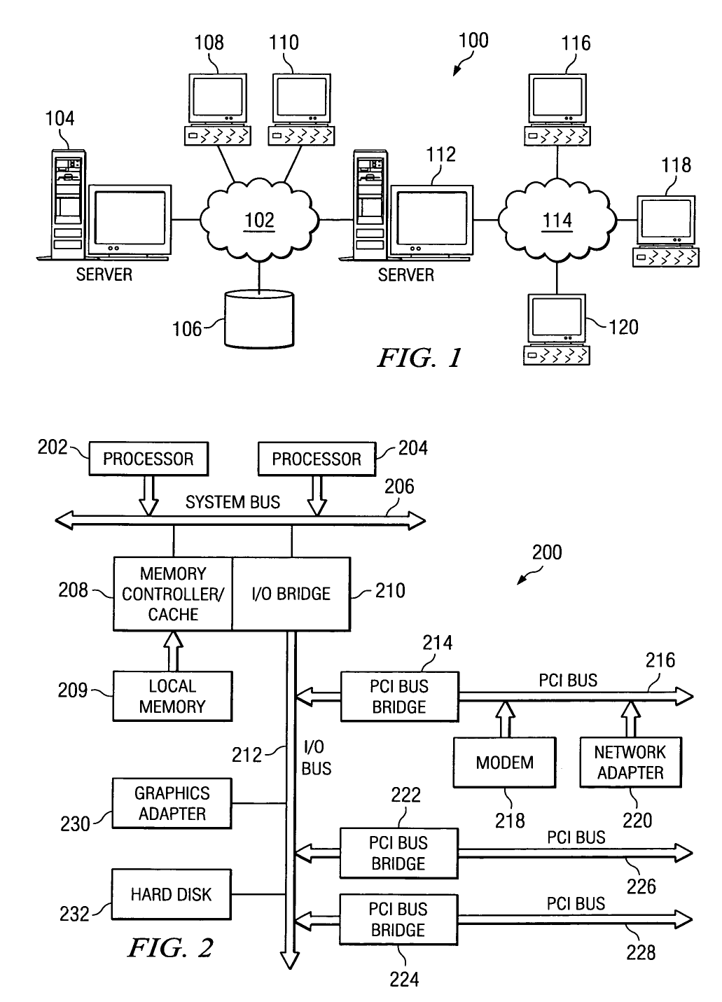

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Server 112 is also connected to private network 114, which connects server 112 to computers 116, 118, 120. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The disclosed illustrative embodiment includes a system and method designed for managing a Storage Area Network (SAN). Some of the terminology used refers to the parts of a SAN. However, the present invention is not limited to the disclosed illustrative embodiment, but can be used for managing any type of system.

Set Theory Notation

Prior to discussing the present invention itself, it is helpful to clarify the notation used. Some of this notation is used in set theory and will be familiar to those who work in this field, although not necessarily to others. A set is a collection of objects chosen from some universe, with the “universe” usually being understood from the context. In the present invention, the elements of a set will be pieces of hardware or software making up a network. Sets are denoted by bold, capital letters or by enclosing the elements of the set in curly brackets. Each element within the set can be shown as either a small letter or as a collection of attributes. For example, set A can be expressed as {a1, a2, a3}, where a1, a2, and a3 are the elements that make up set A. If it is desirable to show the elements as a list of their attributes, the elements can be enclosed inside parentheses within the set: {(a, b, c), (a, d, e), (d, e, f)}. For the purposes of this discussion, a set is considered a collection of points whose coordinates are expressed by their attributes. One example would be a small network consisting of a server and a set of client computers. Each client computer has its own attributes, e.g., identifier (ID), manufacturer or vendor (Vend), model number (model), and operating system (OS). The set of clients can be represented as C={(ID1, Vend1, model1, OS1), {(ID2, Vend2, model2, OS2), {(ID3, Vend3, model3, OS3), etc.}

The symbols used in discussing sets and their elements are:

| | | |
|---|---|---|
| Symbol | Read as | Meaning |

Between Sets:

| | | |
|---|---|---|
| A ⊂ B | A is a subset | Every element in A is also |
| | of B | contained in B |
| A ∩ B | Intersection | The set of all elements that are |
| | of A with B | either in set A or in set B or |
| | | in both |
| A ∪ B | Union of | The set of all elements that are |
| | A with B | either in set A or in set B or |
| | | in both |
| A \ B | A minus B | The set of all elements from set |
| | | A that are not in set B |
| Comp (A) | Complement of | The set of all elements that are |
| | A | not in set A |

Between Elements and Sets;

| | | |
|---|---|---|
| a ∈ B | a belongs to B | a is an element in set B |
| a ∉ B | a does not | a is not an element in set B |
| | belong to B | |

Additionally, Boolean operators, such as ∥ (or) and && (and), as well as algebraic notation, such as = (equal), > (greater than), < (less than), ≦ (less than or equal to), and ≧ (greater than or equal to), are used.
Operations:

The illustrative embodiment of the present invention uses a number of operations on sets that allow the policy manager to evaluate the elements of the network that it serves. The operations that are defined in this application for the policy manager are as follows: Filter, Projection, Section, Diagonal, Union, Intersection, SubSet, SetMinus, and Cardinal. Each of these operations will be discussed in greater detail. Examples of these operations are again shown using a basket of fruit for an example. In this example, each fruit is described by the attributes of identifier, fruit type, color, skin type, size, and weight, e.g. (1, apple, green, edible, 4, 5). Basket of fruit B having eight elements is represented thus:
B=
{(1, apple, green, edible, 4, 5),
(2, orange, yellow, inedible, 5, 5),
(3, grape, green, edible, 1, 1),
(4, grape, red, edible, 1, 2),
(5, apple, red, edible, 5, 6),
(6, banana, yellow, inedible, 7, 3),
(7, pear, green, edible, 4, 4),
(8, peach, yellow, edible, 3, 5)}.
Filter: This operation is used to locate those elements of the set that fit (or do not fit) certain criteria. For instance, the basket of fruit B can be filtered to find the set of fruit G that are green. In set theory, this can be expressed as,
   G={(a, b, c, d, e, f)εB,cε{green}},
that is, the set G is the set of all points in set B for which attribute c (color) belongs to the set that contains only green. In the proposed system, this operation is expressed by,
   Filter (set, t/f, value-1, t/f, value-2, . . . ).
In this notation, the value of an attribute can be given in three different ways; (a) value-n can be a single value with a preceding true/false indicator, (b) value-n can be a set of values; if no t/f value is given, it is assumed to be designated true, or (c) by designating simply “true”, no constraint is applied to that attribute.
   If the policy is to have fruit that are green or yellow, the expression would read,
   Filter (B, true, true, false, {green, yellow}, true, true, true),
which is to say, set B should be checked; if the third attribute is not in the set containing green and yellow, they should be output as errors.
   Set B can also be filtered by checking several attributes at the same time. If the policy involves locating all fruits with edible skins that also have a weight of 5, the additional attributes and their limitations can be added, e.g., G={(a, b, c, d, e, f)εB, dε{edible} && fε{5, 6}}. As a filtering operation, this is written
   Filter (B, true, true, true, (edible}, true, {5, 6})
Projection: Projection taken by itself is used to find all of the existing values of a given attribute. In usage, projection is generally combined with other operations and as such has two parts. Depending on the second step, the combined operation will determine either a) whether all values of the given attribute are members of a given set or b) whether the number of different values of the attribute meets a given numerical limitation. To give the first set of information, one can use the operations
   Projection(B, attribute, SetIn, A) or its opposite Projection(B, attribute, SetNotIn, A).
Depending on whether one uses SetIn or SetNotIn, the operation takes set B and determines all the existing values of the given attribute, a concept that is similar to projecting the set onto the one axis that is represented by that attribute in a multi-axis universe. Using the set of projected values, which can be called set C, the operation then determines if set C is a subset of set A. The operation
   Projection(B, fruitType, SetIn, S)
uses set B above and projects it on the attribute fruitType, the output from the projection is set C={apple, orange, grape, banana, pear, peach}. If this set C is a subset of set S, the operation will return an empty or null set (i.e., there are no exceptions to the rule). However, if set C is not a subset of set S, the entire set A will be returned as an exception to the rule.
   To find whether the number of values of an attribute has a certain value or is within a certain range, one can write
      Projection(B, attribute, SizeIn, A) or its opposite
      Projection(B, attribute, SizeNotIn, A).
For example, if one wants to ensure that there are at least four types of fruit in the basket, one can write the following expression
   Projection (B, fruitType, SizeNotIn, {1, 2, 3})
to make the determination. In this example, the existing fruit types are again projected as C={apple, orange, grape, banana, pear, peach}. Since there are six elements in set C, the size of the set is not 1, 2, or 3. Therefore, the output is a null set, indicating that this set met the limitations. If set B had not met this limitation, the entire set B would be output.
Section: The section operation is used to divide a set into smaller sets where the elements of the smaller sets share an attribute. There will be as many smaller sets as there are values for the attribute. For example, the set of fruit can be divided into smaller sets by fruit type. We would write this instruction
   Section (B, fruit type).
In the example, this would result in 6 smaller sets, one for each of the fruit types found in the projection operation. One set would contain both element 1 (green apple) and element 5 (red apple); another set would contain item 3 (green grape) and item 4 (red grape). The remaining four sets would each contain one item, either item 2 (yellow orange), item 6 (yellow banana), item 7 (green pear), or item 8 (yellow peach).
Diagonal: This operation receives a set A and looks to see if all elements of A are part of a “diagonal” subset of A. A diagonal subset is defined as one in which all the attributes have the same value. For example, each element of set A contains two attributes a₁ and a₂, so a diagonal subset is one in which a₁=a₂. If A={(1, 1), (1, 2), (1, 3), (2, 1), (2, 2), (2, 3), (3, 1), (3, 2), (3, 3)}, then the diagonal subset of A is {(1, 1), (2, 2), (3, 3)}. The output of the Diagonal operation is the points of the set that are not in the diagonal subset. For the command
   Diagonal A
The output would be {(1, 2), (1, 3), (2, 1), (2, 3), (3, 1), (3, 2)}.
Union: This operation is the same as the union operation in set theory. The operation receives two or more sets and outputs a new set that has all the elements that were in at least one of the sets being joined. Given set X={1, 2, 3}, set Y={4, 5, 6}, and set Z=(7, 8), the operation
   Union (X, Y, Z)
would give the output {1, 2, 3, 4, 5, 6, 7, 8}
Intersection: This operation is also the same as its counterpart in set theory. The result of this operation is to form a new set that contains only those elements that are in both of the sets. Using sets X and Y above, the operation
   Intersection (X, Y)
would give an empty (null) set as output, since these two sets contain no elements in common. However, if set W={1, 3, 5, 7, 9}, then
   Intersection (X, W)
would have as output the set {1, 3}.
Subset: This operation receives two sets A, B as input, plus a designation whether the relationship is checked for truth or falsehood. The output can be determined thus:

$$\begin{matrix}Subset ( A , B , true ) = ϕ ( null set ) if A δ B \\ = A otherwise \\ Subset ( A , B , false ) = A if A δ B \\ = ϕ otherwise\end{matrix}$$
Thus, the purpose of this command is to check that all of set A is also in set B; unlike the other commands, the response is either all of set A or nothing.
SetMinus: This operation corresponds to A\B (A minus B) in set theory. The operation receives two sets A and B as input; the output is a set that contains all elements of A that are not elements of B. Said another way, any elements that are common to A and B are removed from A to form the new set. For example, if A={1, 2, 3, 4, 5, 6, 7, 8, 9, 10} and B={2, 4, 6, 8, 10}, then the operation
   SetMinus (A, B)
will have as its output the set {1, 3, 5, 7, 9}.
Cardinal: This operation receives a set A that contains other sets, e.g. A={B, C, D, E}, a number, and a true/false indicator. Each of the sets in set A are checked to see how many elements they contain. If the indicator is true, the operation returns the sets that do not have this cardinality; if the indicator is false, the operation returns the sets that have this cardinality. That is, the operation will always return sets that do not meet the rule. For example, if B={1, 2, 3}, C={1, 3}, D={2, 4}, and E={5}, then the operation
   Cardinal (A, 2, true)
will output the set {B, D}, while
   Cardinal (A, 2, false)
will output the set (C, E).
As seen in the operation Projection, Cardinal can be combined with other operations.

### EXAMPLES

The operations described in the illustrative examples here can be combined in many ways to model the policy statements that are to be enforced. Some examples are shown with corresponding diagrams to highlight how the policies can be checked.

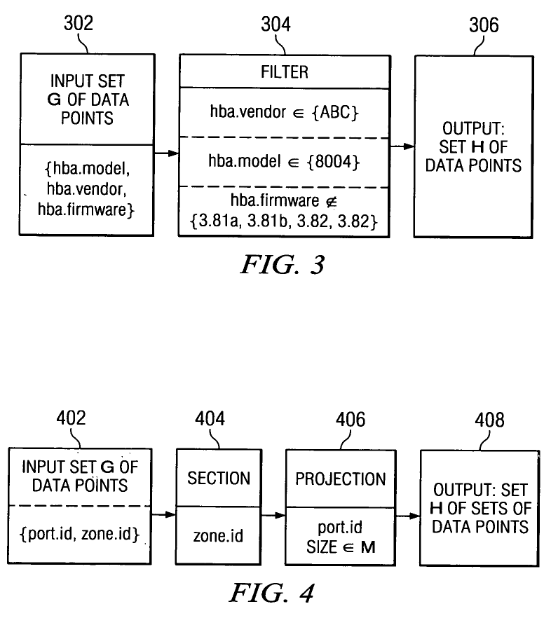

Policy 1: A host bus adapter (HBA) is an I/O adapter that sits between the host computer's bus and a fiber channel loop and manages the transfer of information between the two channels, performing many low-level interface functions. The policy exists that all HBAs of the type 8004 from vendor ABC must have a firmware level of 3.81a, 3.81b, or 3.82. This policy can be checked with a filter operation as is shown in FIG. 3.

The process starts with the list of all monitored systems. The set G contains information on all HBAs and is the input set 302. The filter operation 304 is performed to provide as an output 306 the set H of all HBAs that do not comply with this policy. If we assume for this example that a record in set G contains the fields (a) system.id, (b) hba.id, (c) hba.vendor, (d) hba.model, and (e) hba.fw, the filter operation reads,
Filter (G, true, true, {ABC}, {8004}, false, {3.81a, 3.81b, 3.82})
   Thus, H is the set of those points in set G for which field c (hba.vendor) is equal to ABC, field d (model) is equal to 8004 and field e (firmware) is NOT equal to the listed versions.

Policy 2: It is a policy that there should be no more than n ports in a zone (and no less than m, where m≦n). This policy can be checked using a combination of the Section, Projection, and Cardinal operations, shown in FIG. 4. The input set G of data points 402 contain a port ID and a zone ID. The operations performed are Section (step 404) and Projection with Cardinal (step 406) as detailed below, to provide output set H (step 408). To simplify notation, the points between m and n, i.e., {m, m+1, m+2, . . . n} form set M.

| Operation | Output |
|---|---|
| Section (G, zone.id) | {{A}, {B}, {C}, etc.} |
| | (one set per zone) |
| Projection ({{A}, {B}, {C}, | Set H, consisting of any of |
| etc.}, port.id, SizeNotIn, | the sets {{A}, {B}, {c}, |
| M) | etc.} that have less than m |
| | or greater than n ports |

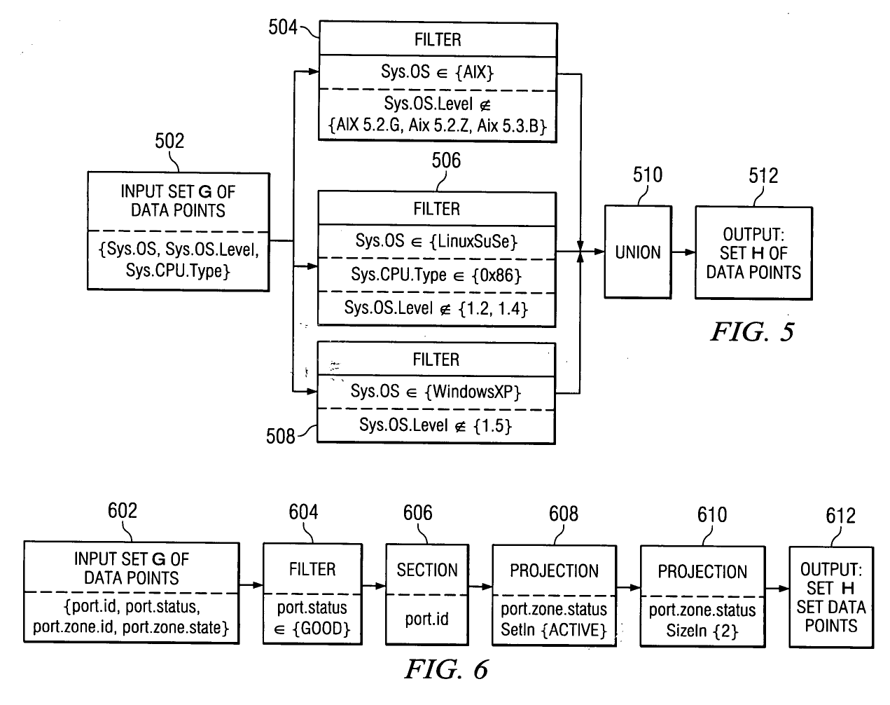

Policy 3: FIG. 5 demonstrates a policy in which the use of union is required. The policy is simply that each operating system must have a recent version of the software; this translates to the following statement: if the system operating system (OS) is AIX, the software level must be Aix 5.2.G, Aix 5.2.Z, or Aix.5.3.B; if the system OS is Linux SuSe and the central processing unit (CPU) type is 0x86, the software level must be Suse1.2 or Suse1.4; if the system OS is Windows XP, the software level must be Win 1.5. Input set G has the attributes (Sys.OS, Sys.OS.Level, Sys.CPU.Type). This set of data points will be input to each of the three filter operations 504, 506, and 508, each of which check one of the requirements. The outputs from the three filter operations 504, 506, and 508 are then joined by a Union operation 510 to create one large set H of exceptions to the rules. Output set H will contain any systems that do not reflect the updated operating system software desired.

Policy 4: A switch in a storage area network (SAN) can have a number of ports, e.g., from 8-128, depending on the application. Zones are used to define groups of elements that need to be able to communicate with each other, e.g., storage devices and servers. Each port can be defined in one or more of these zones. Additionally, the zone state can be active or inactive; the port status can be good or offline. If a port is not defined in any zone, it is assigned to a default zone, whose state is inactive. To govern these, a policy has been established that all ports in good status must be assigned to an active zone. It is possible for a port to have an assignment to both an active zone and an inactive zone, in which case, this port meets the policy.

This policy is shown in FIG. 6. The input set 602 for this policy is set G, each element of which contains a port ID, port status, zone ID, and zone state. Set G is first filtered (step 604) to pass only those data points for which the port status has a value that is in the set {good}, since the policy is not interested in offline ports. All points having a port status of good are then sectioned (step 606) by port.id. The output of this operation is a set H containing smaller sets, each of the smaller sets having the data points for one port, i.e., one record for each zone that the port belongs to. Two projections are then performed, one after another, on the remaining sets.

The first projection (step 608) is made onto the zone status with an accompanying test to determine whether the zone status is in the set {active}. All sets that meet this criterion, e.g., every record in the set has an active zone status, is dropped; only those sets that have at least one record that does not have an active status for the zone are passed on to the next operation. The second projection (step 610) is also onto the port.zone.status, but this time the size of the set is checked. If there are two values for zone status, then logically, at least one record in the set has an active zone status. These records are dropped; the output set H contains only those sets whose port has no active zone (step 612) and thus break the policy. Set H is reported for correction.

The examples given above show how operations using set theory can be used to manage large networks, especially networks for which many different elements, different attributes, and different values exist. The operations defined can be used to implement a large variety of policies regarding such a network and to report on the compliance or non-compliance of the elements and the relationships between elements.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing a plurality of computer systems attached to a network, said method comprising the computer implement steps of:
for each type of element in said plurality of computer systems, defining attributes that are of interest in the operation of said computer systems;
for each element in said plurality of computer systems, assigning values to each of said attributes associated with said element;
defining a policy concerning a first set of said elements in terms of relationships between a corresponding first set of values of said attributes associated with said first set of elements and a second set of desired values; and
performing at least one operation, chosen from a group of set operations, on said first set of values to determine if said first set of values meets said policy.

2. The method of claim 1, further comprising providing a report on compliance to said policy by said first set of elements.

3. The method of claim 1, wherein said performing step performs an operation chosen from the group of set operations consisting of: filter, projection, section, diagonal, union, intersection, subset, setminus, and cardinal.

4. The method of claim 1, wherein said reporting step comprises reporting elements that did not comply with said policy.

5. The method of claim 1, wherein said defining step uses the relationships of “belongs to” and “does not belong to”.

6. The method of claim 1, wherein said defining step uses multiple relationships joined by the operations “and”, “or”, and “not”.

7. A computer program product in a computer readable medium for managing enforcement of a set of policies on a plurality of computer systems attached to a network, said computer program product comprising:
first instructions for defining, for each type of element in said plurality of computer systems, attributes that are of interest in the operation of said computer systems;
second instructions for assigning, for each element in said plurality of computer systems, values to each of said attributes associated with said element;
third instructions for defining a policy concerning a first set of said elements in terms of relationships between a corresponding first set of values of said attributes associated with said first set of elements and a second set of values; and
fourth instructions for performing at least one operation, chosen from a group of set operations, on said first set of values to determine if said first set of values meets said policy.

8. The method of claim 1, further comprising fifth instructions for providing a report on compliance to said policy by said first set of elements.

9. The method of claim 6, wherein said fourth instruction performs an operation chosen from the group of set operations consisting of: filter, project, section, diagonal, union, intersection, subset, setminus, and cardinal.

10. The method of claim 6, wherein said fifth instruction comprises reporting elements that did not comply with said policy.

11. The method of claim 6, wherein said third instruction uses the relationships of “belongs to” and “does not belong to”.

12. The method of claim 6, wherein said third instruction uses multiple relationships joined by the operations “and”, “or”, and “not”.

13. A computer system comprising:
a processor having a connection to a network;
a keyboard connected to input information to said processor;
an output device for providing reporting capabilities;
a set of instructions stored in memory and connected to be executed by said processor, said set of instructions comprising:
first instructions for defining, for each type of element in a plurality of computer systems that are connected to be managed by said computer system, attributes that are of interest in the operation of said computer systems;
second instructions for assigning, for each element in said plurality of computer systems, values to each of said attributes associated with said element;
third instructions for receiving a policy concerning a first set of said elements defined in terms of relationships between a corresponding first set of values of said attributes associated with said first set of elements and a second set of values; and
fourth instructions for performing at least one operation, chosen from a group of set operations, on said first set of values to determine if said first set of values meets said policy.

14. The computer system of claim 6, further comprising fifth instructions for providing a report on compliance to said policy by said first set of elements.

15. The computer system of claim 11, wherein said fourth instruction performs an operation chosen from the group of set operations consisting of: filter, project, section, diagonal, union, intersection, subset, setminus, and cardinal.

16. The computer system of claim 11, wherein said fifth instruction comprises reporting elements that did not comply with said policy.

17. The computer system of claim 11, wherein said third instructions receive policies using the relationships of “belongs to” and “does not belong to”.

18. The computer system of claim 11, wherein said third instructions receive multiple relationships joined by the operations “and”, “or”, and “not”.

19. The computer system of claim 11, wherein said report is provided on said output device.
